(19) United States
(12) Patent Application Publication
(10) Pub. No.: US 2009/0175773 A1
(43) Pub. Date: Jul. 9, 2009

(54) Multilayered Catalyst Compositions

(76) Inventors: Shau-Lin F. Chen, Piscataway, NJ (US); Michel Deeba, East Brunswick, NJ (US); Harold Rabinowitz, Montclair, NJ (US)

Correspondence Address: BASF CATALYSTS LLC, 100 CAMPUS DRIVE, FLORHAM PARK, NJ, 07932, US

(21) Appl. No.: 11/970,879

(22) Filed: Jan. 8, 2008

(51) Int. Cl. B05D 1/36; B01J 23/10; B01J 23/46; B01J 23/42; B01J 23/44; B01D 53/94

(52) U.S. Cl. 423/213.5; 502/325; 502/261; 502/304; 422/177; 427/404

(57) ABSTRACT

A layered, three-way conversion catalyst having the capability of simultaneously catalyzing the oxidation of hydrocarbons and carbon monoxide and the reduction of nitrogen oxides is disclosed. Engine exhaust treatment systems including such catalysts are also provided. The catalyst generally comprises three layers in conjunction with a carrier. The three layers comprise two rhodium-containing layers and one palladium-containing layer. The two rhodium layers can be adjacent to each other, or they can be separated by another precious metal-containing layer. At least one of the two layers comprising the rhodium component comprises an oxygen storage component. Methods of making and using these catalysts are also provided.

### TECHNICAL FIELD

This invention pertains generally to layered catalysts used to treat gaseous steams containing hydrocarbons, carbon monoxide, and oxides of nitrogen. More specifically, this invention is directed to three-way conversion (TWC) catalysts having multiple layers, for example, three or more layers of material.

### BACKGROUND

Catalytic converters containing a TWC catalyst are located in the exhaust gas line of internal combustion engines. Such catalysts promote the oxidation by oxygen in the exhaust gas stream of unburned hydrocarbons and carbon monoxide as well as the reduction of nitrogen oxides to nitrogen.

Known TWC catalysts which exhibit good activity and long life comprise one or more platinum group metals (e.g., platinum, palladium, rhodium, rhenium and iridium) disposed on a high surface area, refractory metal oxide support, e.g., a high surface area alumina coating. The support is carried on a suitable carrier or substrate such as a monolithic carrier comprising a refractory ceramic or metal honeycomb structure, or refractory particles such as spheres or short, extruded segments of a suitable refractory material. TWC catalysts can be manufactured in many ways. U.S. Pat. No. 6,478,874, for example, sets forth a system for catalytic coating of a substrate. Details of a TWC catalyst are found in, for example, U.S. Pat. Nos. 4,714,694 and 4,923,842. U.S. Pat. Nos. 5,057,483; 5,597,771; 7,022,646; and WO95/35152 disclose TWC catalysts having two layers with precious metals. U.S. Pat. No. 6,764,665 discloses a TWC catalyst having three layers, including a palladium layer having substantially no oxygen storage components.

Multilayered catalysts are widely used in TWC. It is a continuing goal to develop three-way conversion catalyst systems that have the ability to oxidize hydrocarbons and carbon monoxide while reducing nitrogen oxides to nitrogen. There is also a goal to utilize components of TWC catalysts, especially the precious metals, rhodium, for example, as efficiently as possible.

### SUMMARY

The present invention relates to a layered catalyst composite of the type generally referred to as a three-way conversion catalyst having the capability of simultaneously catalyzing the oxidation of hydrocarbons and carbon monoxide and the reduction of nitrogen oxides. In a first aspect of the present invention, the structure of the layered catalyst composite of the present invention is designed to have three layers in conjunction with a carrier. The three layers are made up of a first layer comprising a first precious metal selected from a first rhodium component on a first support, a second layer comprising a second precious metal selected from a second rhodium component on a second support, and a third layer comprising a third precious metal component on a third support. By reference to first, second, and third, layers, no limitation is being placed on the location of the layer.

Reference to a “support” in a catalyst layer refers to a material onto or into which precious metals, stabilizers, promoters, binders, and the like are dispersed or impregnated, respectively. A support can be activated and/or stabilized as desired. Examples of supports include, but are not limited to, high surface area refractory metal oxides and composites containing oxygen storage components. One or more embodiments of the present invention include a high surface area refractory metal oxide support comprising an activated compound selected from the group consisting of alumina, silica, silica-alumina, alumino-silicates, alumina-zirconia, lanthana-alumina, lanthana-zirconia-alumina, baria-alumina, baria-lanthana-alumina, baria-lanthana-neodymia-alumina, alumina-chromia, and alumina-ceria.

Another aspect provides an exhaust gas treatment system comprising an upstream composite and a downstream composite. Either the upstream composite or the downstream composite can comprise an inner layer deposited on a first carrier comprising a palladium component and a support, a middle layer deposited on the inner layer, the upstream middle layer comprising a rhodium component and a support, and an outer layer deposited on the middle layer, the outer layer comprising a palladium and a support. The downstream or the upstream composite, correspondingly, can then comprise an inner layer deposited on the first carrier or on a second carrier, this inner layer comprising a rhodium component and a support, a middle layer deposited on the rhodium-containing inner layer, this middle layer comprising a palladium component and a support, and an outer layer deposited on the palladium-containing middle layer, this outer layer comprising a rhodium component and a support.

In a further aspect, a method for treating a gas comprising hydrocarbons, carbon monoxide, and nitrogen oxides comprises: contacting the gas with a catalytic material on a carrier, the catalytic material comprising three layers, the catalytic material comprising three layers, wherein at least two layers each comprise a rhodium component and a support, the support of one of the at least two layers comprises an oxygen storage component, and a third layer comprises a precious metal component and a support; wherein the catalytic material is effective to substantially simultaneously oxidize the carbon monoxide and the hydrocarbons and reduce the nitrogen oxides.

In another aspect, provided is a method of making a layered catalyst composite, the method comprising providing a carrier and coating the carrier with first, second, and third layers of catalytic material; wherein at least two layers each comprise a rhodium component, one of the at least two layers comprising the rhodium component comprises an oxygen storage component, and a third layer comprises a precious metal component and a support.

### BRIEF DESCRIPTION OF DRAWINGS

FIG. 1 is a schematic view showing a configuration of layers on a catalytic member of an exhaust gas treatment system;

FIG. 2 is a schematic view showing another configuration of layers on a catalytic member;

FIG. 3 is a schematic view showing another configuration of layers on a catalytic member;

FIG. 4 is a schematic view showing another configuration of layers on a catalytic member; and

FIG. 5 is a schematic view showing an exhaust treatment system.

### DETAILED DESCRIPTION

The present invention relates to a layered catalyst composite of the type generally referred to as a three-way conversion (TWC) catalyst having the capability of simultaneously catalyzing the oxidation of hydrocarbons and carbon monoxide and the reduction of nitrogen oxides.

To meet stringent emission regulations, many applications of TWC catalysts require high rhodium (Rh) loadings, for example, total loadings of at least 6 to 14 g/ft³ or more. Rh combined with an oxygen storage component (OSC) is effective for NOₓ conversion. Rh combined with a support such as alumina is beneficial for NOₓ and HC conversions and HC light-off. It has been found that to accommodate catalysts requiring relatively high Rh loadings, it is desirable to have at least two distinct Rh layers. In one or more embodiments, one of the Rh layers has low or no oxygen storage components (OSC) where Rh is fixed to a high surface area refractory metal oxide such as alumina. This helps Rh to stay in a metallic form and is useful for HC conversion and its light-off. In other embodiments, the Rh layers have the same composition. This is useful for NOₓ conversions in some applications. In one or more embodiments, an Rh layer has high OSC with Rh being in close proximity to, for example, ceria oxide to promote NOₓ conversion during hard acceleration where exhaust gas flow rate is high. Without attempting to be bound by theory, it appears that the use of multiple coatings, and the accompanying increase in support(s) and OSC(s) enabled better Rh dispersion and effectiveness. In this way, a catalyst of this type can be used to compensate for a portion of geometric surface area (GSA) loss when a substrate is changed from high (e.g., 900 and 600 cpsi) to low (400 and/or 350 cpsi) cell density. Ordering of the Rh layer is not limited. For applications where HC conversion and light-off needs to be enhanced, then the Rh combined with a support can be located in an outer layer of the catalytic material. When NOₓ and/or OSC-time is important, then the Rh with high OSC layer can be located in the outer layer. The purpose is to reduce the mass transfer barrier by locating this Rh with high OSC layer closest to the gas-solid interphase so that gas diffusion limitation can be minimized. In addition, Platinum (Pt) on an OSC can be added to an Rh-containing layer to enhance Rh regeneration through water gas shift reaction.

The Rh layers can be adjacent to each other, or separated by another precious metal containing layer. The Rh layers can be adjacent to each other, or separated by another precious metal containing layer.

In a first aspect of the present invention, the structure of the layered catalyst composite of the present invention is designed to have three layers in conjunction with a carrier. The three layers are made up of a first layer comprising a first precious metal selected from a first rhodium component on a first support, a second layer comprising a second precious metal selected from a second rhodium component on a second support, and a third layer comprising a third precious metal component on a third support.

In one or more embodiments, the catalytic material comprises the rhodium components in amounts to provide a rhodium loading in the catalytic material in the range of 1 to 14 g/ft³. In detailed embodiments, the catalytic material comprises the rhodium components in amounts to provide a rhodium loading in the catalytic material of at least 1 (or 2, 4, 6, 8, 10, 12 or even 14) g/ft³. In an embodiment, at least one of the supports is an oxygen storage component comprising a stabilized ceria-zirconia composite. Other embodiments provide that the first layer, the second layer, or both further comprise a platinum component.

In a detailed embodiment, the two layers comprising the rhodium components, namely, the first and second layers are adjacent to each other. In another embodiment, the third layer is located between the first and second layers, and the third precious metal component comprises a palladium component.

One or more embodiments provide that the first, second, and third supports each independently comprise a compound that is activated, stabilized, or both selected from the group consisting of alumina, silica, silica-alumina, alumino-silicates, alumina-zirconia, lanthana-alumina, lanthana-zirconia-alumina, baria-alumina, baria-lanthana-alumina, baria-lanthana-neodymia-alumina, alumina-chromia, and alumina-ceria.

A further embodiment includes the third layer being deposited on the carrier as an inner layer, the third precious metal component comprises a palladium component; and the third support comprising a high surface area refractory metal oxide; the first layer being deposited on the third layer as a middle layer; and the second layer being deposited on the first layer as an outer layer, and the second support comprises a high surface area refractory metal oxide, and the second layer further comprises an oxygen storage component.

In a detailed embodiment, the layers provided are the inner layer comprising a stabilized alumina, such as gamma alumina, which can be present in an amount in the range of 60 to 90% by weight of the layer, palladium, which can be present in an amount in the range of 0.5 to 2.5% by weight of the layer, and is substantially free of an oxygen storage component; the middle layer comprising a stabilized alumina, such as gamma alumina, which can be present in an amount in the range of 80 to 98% by weight of the layer, rhodium, which can be present in an amount in the range of 0.5 to 2.5% by weight of the layer, and is substantially free of an oxygen storage component; and the outer layer comprising a stabilized alumina, such as gamma alumina, which can be present in an amount in the range of 5 to 20% by weight of the layer; one or more ceria-zirconia oxide composites to provide ceria in an amount in the range of 15 to 30% by weight of the layer, and rhodium, which can be present in an amount in the range of 0.5 to 2.5% by weight of the layer.

In another detailed embodiment, the inner layer comprises a stabilized alumina, such as gamma alumina, which can be present in an amount in the range of 60 to 90% by weight of the layer, palladium, which can be present in an amount in the range of 0.5 to 2.5% by weight of the layer, and is substantially free of an oxygen storage component; the middle layer comprises one or more ceria-zirconia oxide composites to provide ceria in an amount in the range of 15 to 30% by weight of the layer, rhodium, which can be present in an amount in the range of 0.5 to 2.5% by weight of the layer, and is substantially free of an alumina component; and the outer layer comprises a stabilized alumina, such as gamma alumina, which can be present in an amount in the range of 5 to 20% by weight of the layer; one or more ceria-zirconia oxide composites to provide ceria in an amount in the range of 15 to 30% by weight of the layer, and rhodium, which can be present in an amount in the range of 0.5 to 2.5% by weight of the layer.

A further detailed embodiment provides that the inner layer comprises a stabilized alumina, such as gamma alumina, which can be present in an amount in the range of 40 to 70% by weight of the layer, palladium, which can be present in an amount in the range of 1.5 to 3.0% by weight of the layer, and one or more ceria-zirconia oxide composites to provide ceria in an amount in the range of 15 to 30% by weight of the layer; and the middle layer and the outer layer have substantially the same composition, each comprising one or more ceria-zirconia oxide composites to provide ceria in an amount in the range of 5 to 15% by weight of the layer, rhodium, which can be present in an amount in the range of 0.1 to 1.1% by weight of the layer, and a stabilized alumina, such as gamma alumina, which can be present in an amount in the range of 65 to 95% by weight of the layer.

In another embodiment, the first layer is deposited on the carrier as an inner layer, the first support comprises a high surface area refractory metal oxide; the third layer is deposited on the first layer as a middle layer, the third precious metal component comprises a palladium component; and the second layer is deposited on the middle layer as an outer layer, the second support comprises a high surface area refractory metal oxide support, and the second layer further comprises an oxygen storage component.

Another specific embodiment provides that the inner layer comprises a stabilized alumina, such as lanthana-stabilized gamma alumina, which can be present in an amount in the range of 15 to 30% by weight of the layer, rhodium, which can be present in an amount in the range of 0.05 to 2.0% by weight of the layer, and one or more ceria-zirconia oxide composites to provide ceria in an amount in the range of 20 to 40% by weight of the layer; the middle layer comprises a stabilized alumina, such as a lanthana-stabilized gamma alumina, which can be present in an amount in the range of 40 to 70% by weight of the layer, palladium, which can be present in an amount in the range of 0.1 to 2.0% by weight of the layer, and one or more ceria-zirconia oxide composites to provide ceria in an amount in the range of 5 to 20% by weight of the layer; and the outer layer comprises a stabilized alumina, such as a lanthana-zirconia-stabilized gamma alumina, which can be present in an amount in the range of 30 to 50% by weight of the layer, rhodium, which can be present in an amount in the range of 0.05 to 2.0% by weight of the layer, platinum, which can be present in an amount in the range of 0.05 to 2.0% by weight, and one or more ceria-zirconia oxide composites to provide ceria in an amount in the range of 15 to 40% by weight of the layer.

Another aspect provides an exhaust gas treatment system comprising a combination of a first composite and a second composite. The first composite comprises a first inner layer deposited on a first carrier comprising a palladium component and a support, a first middle layer deposited on the first inner layer, the first middle layer comprising a rhodium component and a support, and a first outer layer deposited on the first middle layer, the first outer layer comprising a palladium and a support. The second composite comprises a second inner layer deposited on the first carrier or on a second carrier, the second inner layer comprising a rhodium component and a support, a second middle layer deposited on the second inner layer, the second middle layer comprising a palladium component and a support, and a second outer layer deposited on the second middle layer, the second outer layer comprising a rhodium component and a support. In an embodiment, the first composite is located upstream of the second composite. Alternatively, the second composite can be located upstream of the first composite.

In a further aspect, a method for treating a gas comprising hydrocarbons, carbon monoxide, and nitrogen oxides comprises: contacting the gas with a catalytic material on a carrier, the catalytic material comprising three layers, the catalytic material comprising three layers, wherein at least two layers each comprise a rhodium component, one of the at least two layers comprising the rhodium component a support, the support of one of the at least two layers comprises an oxygen storage component, and a third layer comprises a precious metal component and a support; wherein the catalytic material is effective to substantially simultaneously oxidize the carbon monoxide and the hydrocarbons and reduce the nitrogen oxides. In a detailed embodiment, the gas is at a temperature of 1100 (or in other embodiments, 1000, or 900, or even 800)° C. or less.

In a detailed embodiment, the method further comprises locating the catalytic material in a close-coupled position of an exhaust gas treatment system wherein the catalytic material comprises an inner layer, a middle layer, and an outer layer, the inner layer being deposited on the carrier and comprising a first rhodium component on a first support, the middle layer being deposited on the inner layer and comprising a palladium component on a second support, and the outer layer being deposited on the middle layer and comprising a second rhodium component on a third support; wherein the catalytic material comprises the rhodium components in amounts to provide a rhodium loading in the catalytic material in the range of 1 to 14 g/ft³, and the catalytic material comprises the palladium component in an amount to provide a palladium loading in the catalytic material in the range of 20 to 200 g/ft³.

In another detailed embodiment, the method, further comprises locating the catalytic material in an underfloor position of an exhaust gas treatment system wherein the catalytic material comprises an inner layer, a middle layer, and an outer layer, the inner layer being deposited on the carrier and comprising a first rhodium component on a first support, the middle layer being deposited on the inner layer and comprising a palladium component on a second support, and the outer layer being deposited on the middle layer and comprising a second rhodium component on a third support; wherein the catalytic material comprises the rhodium components in amounts to provide a rhodium loading in the catalytic material in the range of 1 to 14 g/ft³, and the catalytic material comprises the palladium component in an amount to provide a palladium loading in the catalytic material in the range of 5 to 30 g/ft³.

In another aspect, provided is a method of making a layered catalyst composite, the method comprising providing a carrier and coating the carrier with first, second, and third layers of catalytic material; wherein at least two layers each comprise a rhodium component, one of the at least two layers comprising the rhodium component comprises an oxygen storage component and a high surface area refractory metal oxide support, and a third layer comprises a precious metal component and a support. In a detailed embodiment, the method comprises depositing the at least two layers comprising the rhodium component adjacent to each other. In another embodiment, the method comprises depositing one of the at least two layers comprising the rhodium component on the carrier, depositing the third layer on the first layer, and depositing the other of the at least two layers comprising the rhodium component on the third layer.

Another aspect provides a layered catalyst composite comprising: a catalytic material on a carrier, the catalytic material comprising an inner layer, a middle layer, and an outer layer, the inner layer deposited on the carrier comprising a first rhodium component on a first support, the middle layer deposited on the inner layer comprising a palladium component on a second support, and the outer layer deposited on the middle layer comprising a second rhodium component on a third support; wherein the catalytic material is effective to substantially simultaneously oxidize carbon monoxide and hydrocarbons and reduce nitrogen oxides; wherein the catalytic material comprises the rhodium components in amounts to provide a rhodium loading in the catalytic material in the range of 1 to 14 g/ft³, and the catalytic material comprises the palladium component in an amount to provide a palladium loading in the catalytic material in the range of 5 to 200 g/ft³. In a detailed embodiment, the palladium component is present in an amount to provide a palladium loading in the catalytic material in the range of 5 to 30 g/ft³. Another embodiment provides that the inner layer, the outer layer, or both further comprise a platinum component in an amount in the range of 1 to 6 g/ft³.

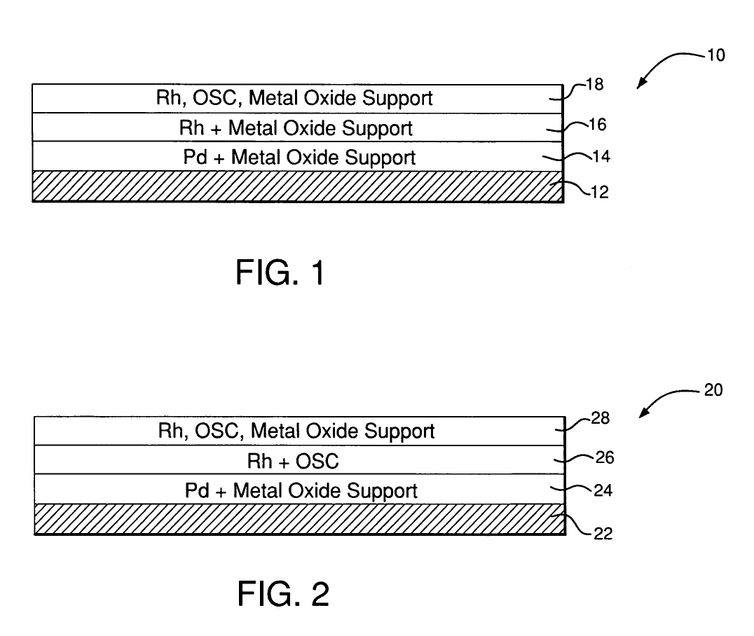

The catalytic composites according to embodiments of the invention may be more readily appreciated by reference to the figures, which are merely exemplary in nature and in no way intended to limit the invention or its application or uses. Referring in particular to FIG. 1, a configuration of the catalytic member 10 of an exhaust gas treatment system is shown in accordance with one embodiment of the present invention. The catalytic member 10 comprises a substrate 12, typically a honeycomb monolith substrate, which is coated with an inner washcoat layer 14, containing a precious metal component, for example palladium and a metal oxide support; a middle washcoat layer 16 containing rhodium and a metal oxide support; and an outer layer 18 containing rhodium, a metal oxide support, and an OSC. The precious metal catalysts and oxygen storage components used in the practice of embodiments of the present invention are discussed in more detail below.

In FIG. 2, a configuration of the catalytic member 20 of an exhaust gas treatment system is shown in accordance with one embodiment of the present invention. In this embodiment, the catalytic member 20 comprising a substrate 22, typically a honeycomb monolith substrate, is coated with the inner layer 24 containing a precious metal component, for example, palladium and a metal oxide support; the middle layer 26 containing a rhodium component and an OSC; and the outer layer 28 containing rhodium, a metal oxide support, and an OSC.

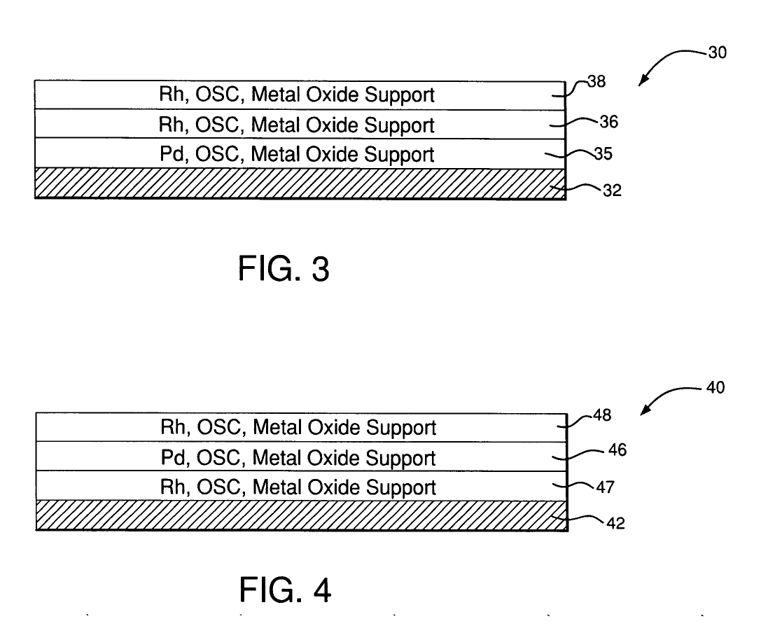

In FIG. 3, a configuration of the catalytic member 30 of an exhaust gas treatment system is shown in accordance with another embodiment of the present invention. In this embodiment, the catalytic member 30 comprising a substrate 32, typically a honeycomb monolith substrate, is coated with the inner layer 35 containing a precious metal component, for example, palladium, an OSC, and a metal oxide support; the middle layer 36 and the outer layer 38 both containing rhodium, a metal oxide support, and an OSC.

In FIG. 4, a configuration of the catalytic member 40 of an exhaust gas treatment system is shown in accordance with another embodiment of the present invention. In this embodiment, the catalytic member 40 comprising a substrate 42, typically a honeycomb monolith substrate, is coated with the inner layer 47 containing a rhodium, an OSC, and a metal oxide support; the middle layer 46 containing a precious metal component, for example, palladium, an OSC, and a metal oxide support, and the outer layer 48 containing rhodium, a metal oxide support, and an OSC.

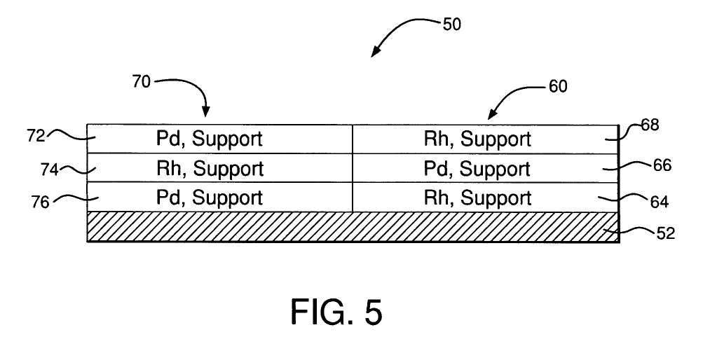

As used herein, the terms “upstream” and “downstream” refer to relative locations according to the flow of an engine exhaust gas stream. The gas stream first contacts the upstream composite and next contacts the downstream composite. In this way, the upstream and downstream composites can be on the same carrier, or be situated in the exhaust on separate carriers, serially. In FIG. 5, an exhaust treatment system 50 is shown having an upstream composite 70 is provided in combination with a downstream composite 60, both located on the same substrate 52. The upstream composite 70 contains an inner layer 76 of palladium and a support, a middle layer 74 of rhodium and a support, and an outer layer 72 of palladium and a support. The upstream composite, in this figure, extends only a portion of the length of the carrier 52. The downstream composite 60 contains an inner layer 67 of rhodium and a support, a middle layer 66 of palladium and a support, and an outer layer 68 of rhodium and a support. The downstream composite, in this figure, extends only a portion of the length of the carrier 52. Another embodiment provides that composite 70 is located downstream and composite 60 is located upstream.

Details of the components of a gas treatment article and system according to embodiments of the invention are provided below.

### The Carrier

According to one or more embodiments, the carrier may be any of those materials typically used for preparing TWC catalysts and will preferably comprise a metal or ceramic honeycomb structure. Any suitable carrier may be employed, such as a monolithic carrier of the type having a plurality of fine, parallel gas flow passages extending therethrough from an inlet or an outlet face of the carrier, such that passages are open to fluid flow therethrough. The passages, which are essentially straight paths from their fluid inlet to their fluid outlet, are defined by walls on which the catalytic material is coated as a “washcoat” so that the gases flowing through the passages contact the catalytic material. The flow passages of the monolithic carrier are thin-walled channels which can be of any suitable cross-sectional shape and size such as trapezoidal, rectangular, square, sinusoidal, hexagonal, oval, circular, etc. Such structures may contain from about 60 to about 1200 or more gas inlet openings (i.e., “cells”) per square inch of cross section.

The ceramic carrier may be made of any suitable refractory material, e.g., cordierite, cordierite-α alumina, silicon nitride, zircon mullite, spodumene, alumina-silica magnesia, zircon silicate, sillimanite, magnesium silicates, zircon, petalite, α-alumina, aluminosilicates and the like.

The carriers useful for the layered catalyst composites of the present invention may also be metallic in nature and be composed of one or more metals or metal alloys. The metallic carriers may be employed in various shapes such as corrugated sheet or monolithic form. Preferred metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt. % of the alloy, e.g., 10-25 wt. % of chromium, 3-8 wt. % of aluminum and up to 20 wt. % of nickel. The alloys may also contain small or trace amounts of one or more other metals such as manganese, copper, vanadium, titanium and the like. The surface or the metal carriers may be oxidized at high temperatures, e.g., 1000° C. and higher, to improve the corrosion resistance of the alloy by forming an oxide layer on the surface the carrier. Such high temperature-induced oxidation may enhance the adherence of the refractory metal oxide support and catalytically-promoting metal components to the carrier.

### Preparation of the Layered Catalyst Composite

The layered catalyst composite of the present invention may be readily prepared by processes well known in the prior art, see for example U.S. Patent Publication No. 2004/0001782, incorporated herein by reference in its entirety. A representative process is set forth below. As used herein, the term “washcoat” has its usual meaning in the art of a thin, adherent coating of a catalytic or other material applied to a substrate carrier material, such as a honeycomb-type carrier member, which is sufficiently porous to permit the passage there through of the gas stream being treated.

The catalyst composite can be readily prepared in layers on a monolithic carrier. For a first layer of a specific washcoat, finely divided particles of a high surface area refractory metal oxide such as gamma alumina are slurried in an appropriate vehicle, e.g., water. The carrier may then be dipped one or more times in such slurry or the slurry may be coated on the carrier such that there will be deposited on the carrier the desired loading of the metal oxide, e.g., about 0.5 to about 2.5 g/in³. To incorporate components such as precious metals (e.g., palladium, rhodium, platinum, and/or combinations of the same), stabilizers and/or promoters, such components may be incorporated in the slurry as a mixture of water soluble or water-dispersible compounds or complexes. Thereafter the coated carrier is calcined by heating, e.g., at 450-600° C. for about 1 to about 3 hours. Typically, when palladium is desired, the palladium component is utilized in the form of a compound or complex to achieve dispersion of the component on the refractory metal oxide support, e.g., activated alumina. For the purposes of the present invention, the term “palladium component” means any compound, complex, or the like which, upon calcination or use thereof, decomposes or otherwise converts to a catalytically active form, usually the metal or the metal oxide. Water-soluble compounds or water-dispersible compounds or complexes of the metal component may be used as long as the liquid medium used to impregnate or deposit the metal component onto the refractory metal oxide support particles does not adversely react with the metal or its compound or its complex or other components which may be present in the catalyst composition and is capable of being removed from the metal component by volatilization or decomposition upon heating and/or application of a vacuum. In some cases, the completion of removal of the liquid may not take place until the catalyst is placed into use and subjected to the high temperatures encountered during operation. Generally, both from the point of view of economics and environmental aspects, aqueous solutions of soluble compounds or complexes of the precious metals are utilized. For example, suitable compounds are palladium nitrate or rhodium nitrate. During the calcination step, or at least during the initial phase of use of the composite, such compounds are converted into a catalytically active form of the metal or a compound thereof.

A suitable method of preparing any layer of the layered catalyst composite of the invention is to prepare a mixture of a solution of a desired precious metal compound (e.g., palladium compound or palladium and platinum compounds) and at least one finely divided, high surface area, refractory metal oxide support, e.g., gamma alumina, which is sufficiently dry to absorb substantially all of the solution to form a wet solid which later combined with water to form a coatable slurry. In one or more embodiments, the slurry is acidic, having a pH of about 2 to less than about 7. The pH of the slurry may be lowered by the addition of an adequate amount of an inorganic or an organic acid to the slurry. Combination of both can be used when compatibility of acid and raw materials is considered. Inorganic acids include, but are not limited to, nitric acid. Organic acids include, but are not limited to, acetic, propionic, oxalic, malonic, succinic, glutamic, adipic, maleic, fumaric, phthalic, tartaric, citric acid and the like. Thereafter, if desired, water-soluble or water-dispersible compounds of oxygen storage components, e.g., cerium-zirconium composite, a stabilizer, e.g., barium acetate or nitrate, and a promoter, e.g., lanthanum acetate or nitrate, may be added to the slurry.

In one embodiment, the slurry is thereafter comminuted to result in substantially all of the solids having particle sizes of less than about 20 microns, i.e., between about 0.1-15 microns, in an average diameter. The comminution may be accomplished in a ball mill or other similar equipment, and the solids content of the slurry may be, e.g., about 15-60 wt. %, more particularly about 25-40 wt. %.

Additional layers may be prepared and deposited upon the first layer in the same manner as described above for deposition of the first layer upon the carrier.

The catalytic layers may also contain stabilizers and promoters, as desired. Suitable stabilizers include one or more non-reducible metal oxides wherein the metal is selected from the group consisting of barium, calcium, magnesium, strontium, lanthanum, and mixtures thereof. Preferably, the stabilizer comprises one or more oxides of barium and/or strontium. Suitable promoters include one or more oxides of one or more rare earth metals selected from the group consisting of lanthanum, zirconium, praseodymium, yttrium, and mixtures thereof.

A catalytic layer may also contain an oxygen storage component. Reference to OSC (oxygen storage component) refers to an entity that has multi-valence state and can actively react with oxidants such as oxygen or nitrous oxides under oxidative conditions, or reacts with reductants such as carbon monoxide (CO) or hydrogen under reduction conditions. Typically, the oxygen storage component will comprise one or more reducible oxides of one or more rare earth metals. Examples of suitable oxygen storage components include ceria. Praseodymia can also be included as an OSC. Delivery of an OSC to the layer can be achieved by the use of, for example, mixed oxides. For example, ceria can be delivered by a mixed oxide of cerium and zirconium, and/or a mixed oxide of cerium, zirconium, and neodymium. For example, praseodymia can be delivered by a mixed oxide of praseodymium and zirconium, and/or a mixed oxide of praseodymium, cerium, lanthanum, yttrium, zirconium, and neodymium. The term “substantially free of an oxygen storage component” refers to having a low, very low amount, or no OSC in the layer. A very low amount of OSC is understood to mean less than or equal to approximately 1-4% by weight OSC in the layer. A low amount of OSC is understood to mean approximately 4-12% by weight OSC in the layer. A medium amount of OSC is understood to mean approximately 12-30% by weight OSC in the layer. A high amount of OSC is understood to mean 30% or more by weight OSC in the layer.

Unless otherwise indicated, all numbers expressing quantities of ingredients, reaction conditions, and so forth used in the specification and claims are to be understood as being modified in all instances by the term “about.”

Before describing several exemplary embodiments of the invention, it is to be understood that the invention is not limited to the details of construction or process steps set forth in the following description. The invention is capable of other embodiments and of being practiced in various ways.

### EXAMPLES

The following non-limiting examples shall serve to illustrate the various embodiments of the present invention. In each of the examples, the carrier was cordierite.

### Example 1

A composite having a catalytic material was prepared using three layers: an inner layer, a middle layer, and an outer layer. In this example, the composition is generally referred to as Pd/Rh/(Rh—Pt). The layered catalyst composite contained platinum, palladium, and rhodium with a total precious metal loading of 95 g/ft³ and with a Pt/Pd/Rh ratio of 27/50/18. The substrate had a cell density of 400 cells per square inch and with wall thickness around 90 μm. The layers were prepared as follows:

### Inner Layer

The components present in the inner layer were baria-stabilized high surface area gamma alumina, palladium, strontium oxide, zirconium oxide, neodymium oxide, and lanthanum oxide at concentrations of approximately 75.0%, 1.6%, 7.0%, 2.2%, 7.0%, and 7.0%, respectively, based on the calcined weight of the catalyst. Strontium oxide was introduced sequentially as hydroxide and acetate salts. Zirconium oxide was introduced as an acetate colloidal solution. Neodymium oxide was introduced as a nitrate colloidal solution. Lanthanum oxide was introduced as a nitrate solution. The total loading of the inner layer was 1.86 g/in³. There was no OSC (oxygen storage component) content in the layer.

Palladium in the form of a palladium nitrate solution was impregnated by planetary mixer (P-mixer) onto the stabilized alumina to form a wet powder while achieving incipient wetness. An aqueous slurry was formed by combining all of the above components with water and adequate amount of acetic acid to bring pH to around 4, and milling to a particle size of 90% less than 12 microns. The slurry was coated onto a cordierite carrier using deposition methods known in the art for depositing the catalyst on a cordierite substrate. After coating, the carrier plus the inner layer were dried and then calcined at a temperature of 550° C. for about 1 hour.

### Middle Layer

The components present in the middle layer were a zirconia-lanthana stabilized gamma alumina, a ceria-zirconia composite with 5% by weight ceria content, rhodium, and zirconium oxide, at concentrations of approximately 91.9%, 5.4%, 1.6%, and 1.1%, respectively, based on the calcined weight of the catalyst. The zirconium oxide was introduced as a nitrate colloidal solution. The total loading of the middle layer was 0.92 g/in³. The OSC content in the layer was approximately 0.3%.

An amount of 95% rhodium in the form of a rhodium nitrate solution was impregnated by planetary mixer (P-mixer) onto the stabilized alumina to form a wet powder while achieving incipient wetness. The remainder of rhodium in the form of a rhodium nitrate solution was also impregnated by a P-mixer onto the ceria-zirconia oxide composite with 5% by weight ceria content to form a wet powder while achieving incipient wetness. An aqueous slurry was formed by combining all of the above components with water and under conditions of a pH<4.5, and milling to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The components present in the outer layer were a zirconia-lanthana stabilized alumina; three ceria-zirconia oxide composites with 28%, 20%, 30% by weight of ceria content each; rhodium, platinum, an alumina type binder, and zirconium oxide, at concentrations of approximately 11.0%, 18.4%, 18.4%, 47.7%, 0.8%, 0.09%, 3.0%, and 0.7%, respectively, based on the calcined weight of the catalyst. The zirconium oxide was introduced as a hydroxide colloidal solution. The total loading of the outer layer was 1.36 g/in³. The OSC content in the layer was approximately 23%.

Amounts of 10%, 25%, 20%, and 45% of the rhodium in the form of a rhodium nitrate solution were individually impregnated by planetary mixer (P-mixer) onto the stabilized alumina, the ceria-zirconia oxide composite with 28%, 20%, and 30% by weight of ceria content each, to form wet powders while achieving incipient wetness. An aqueous slurry was formed by combining all of the above components with water, platinum nitrate solution, and nitric acid under conditions of a pH<4.5, and milling to a particle size of 90% less than 12 microns. The slurry was coated onto the cordierite carrier over the middle layer using deposition methods known in the art for depositing the catalyst on a cordierite substrate. After coating, the carrier plus the inner, middle, and outer layers were dried, and then calcined at a temperature of 550° C. for about 1 hour.

### Example 2

A composite having a catalytic material was prepared using three layers: an inner layer, a middle layer, and an outer layer. In this example, the composition is generally referred to as Pd/Rh/(Rh—Pt). The layered catalyst composite contained platinum, palladium, and rhodium with a total precious metal loading of 72 g/ft³ and with a Pt/Pd/Rh ratio of 2/50/20. The substrate had a cell density of 400 cells per square inch and with wall thickness around 90 μm. The layers were prepared as follows:

### Inner Layer

The inner layer had the same composition, slurry preparation, and loading as the inner layer of Example 1.

### Middle Layer

The components present in the middle layer were a ceria-zirconia oxide composite with 20% by weight ceria content, rhodium, an alumina type binder, and zirconium oxide, at concentrations of approximately 92.0%, 1.5%, 5.5%, and 1.0%, respectively, based on the calcined weight of the catalyst. The zirconium oxide was introduced as a nitrate colloidal solution. The total loading of the middle layer was 0.98 g/in³. The OSC content in the layer was approximately 18.4%.

Rhodium in the form of a rhodium nitrate solution was impregnated by planetary mixer (P-mixer) onto the ceria-zirconia oxide composite with 20% by weight ceria content to form a wet powder while achieving incipient wetness. An aqueous slurry was formed by combining all of the above components with water and nitric acid under conditions of a pH<4.5, and milling to a particle size of 90% less than 12 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The outer layer had the same composition, slurry preparation, and loading as the outer layer of Example 1.

### Example 3

### Comparative Example

A composite having a catalytic material was prepared using two layers: an inner layer and an outer layer. In this example, the composition is generally referred to as Pd/(Rh—Pt). The layered catalyst composite contained platinum, palladium, and rhodium with a total precious metal loading of 70 g/ft³ and with a Pt/Pd/Rh ratio of 32/50/18. The substrate had a cell density of 400 cells per square inch and with wall thickness around 90 μm. In this comparative example, the layers were as follows:

### Inner Layer

The inner layer had the same composition, slurry preparation, and loading as the inner layer of Example 1. A platinum radial zone covering 75% of the cross-section area and having a loading of 0.0192 g/in³ was deposited on the inner layer.

### Outer Layer

The components present in the outer layer were a zirconia-lanthana stabilized alumina; a ceria-zirconia oxide composite with 28% by weight ceria content, a ceria-zirconia oxide composite with 20% by weight ceria content, a ceria-zirconia oxide composite with 30% by weight ceria content, rhodium, platinum, a binder, and zirconium oxide, at concentrations of approximately 7.6%, 19.0%, 19.0%, 49.5%, 0.8%, 0.09%, 3.1%, and 0.8%, respectively, based on the calcined weight of the catalyst. The zirconium oxide was introduced as a hydroxide colloidal solution. The total loading of the outer layer was 1.31 g/in³. The OSC content in the layer was approximately 24%.

Amounts of 10%, 25%, 20%, and 45% of the rhodium in the form of a rhodium nitrate solution were individually impregnated by planetary mixer (P-mixer) onto the stabilized alumina, the ceria-zirconia oxide composite with 28% by weight ceria content, the ceria-zirconia oxide composite with 20% by weight ceria content, and the ceria-zirconia oxide composite with 30% by weight ceria content, respectively, to form wet powders while achieving incipient wetness. An aqueous slurry was formed by combining all of the above components with water and under conditions of a pH<4.5, and milling to a particle size of 90% less than 12 microns. The slurry was coated onto the cordierite carrier over the middle layer using deposition methods known in the art for depositing the catalyst on a cordierite substrate. After coating, the carrier plus the inner, radial, and outer layers were dried, and then calcined at a temperature of 550° C. for about 1 hour.

### Example 4

Testing

The catalyst composites prepared in Examples 1, 2, and 3 were fuel-cut aged for 100 hours at a maximum bed temperature of 920° C. After aging, the composites were evaluated using a laboratory reactor system with various test protocols, including OBD delay time, model lambda transients, and simulated FTP drive cycles.

HC/CO/NOₓ conversions were measured while the temperature was rapidly raised to 500° C. Hydrocarbon, CO, and NOₓ concentrations were measured using a Fourier Transform Infrared (FTIR) analyzer.

TABLE 1

| | HC | CO/10 | NOₓ |
|---|---|---|---|
| | (modal mg/mi) | (modal mg/mi) | (modal mg/mi) |
| Example 1 | 34 | 16 | 36 |
| Example 2 | 42 | 15 | 32 |
| Example 3 | 39 | 18 | 107 |

Table 1 shows that the three-layered composites of Examples 1 and 2 show improved conversions of CO and NOₓ compared to the two-layered composite of Example 3.

### Example 5

A composite having a catalytic material was prepared using three layers: an inner layer, a middle layer, and an outer layer. In this example, the composition is generally referred to as Pd/Rh/Rh. The layered catalyst composite contained palladium and rhodium with a total precious metal loading of 80 g/ft³ and with a Pt/Pd/Rh ratio of 0/5/1. The substrate had a volume of 102.5 in³ (1.7 L) and a cell density of 600 cells per square inch and with wall thickness around 113 μm. The layers were prepared as follows:

### Inner Layer

The components present in the inner layer were high surface area lanthana-stabilized gamma alumina, a ceria-zirconia oxide composite with 45% by weight ceria content, palladium, and barium oxide, at concentrations of approximately 55.1%, 41.4%, 2.1%, and 1.4%, respectively, based on the calcined weight of the catalyst. The total loading of the inner layer was 1.81 g/in³. The barium oxide was introduced as an acetate colloidal solution. The OSC content in the layer was approximately 18.6%.

An aqueous slurry was formed by combining all of the above components with water, and milling to a particle size of 90% less than 10 microns. The slurry was coated onto a cordierite carrier using deposition methods known in the art for depositing the catalyst on a cordierite substrate. After coating, the carrier plus the inner layer were dried and then calcined at a temperature of 500° C. for about 1 hour.

### Middle Layer

The components present in the middle layer were high surface area stabilized gamma alumina, a ceria-zirconia oxide composite with 45% by weight ceria content, rhodium, and zirconium oxide at concentrations of approximately 80.4%, 16.1%, 0.2%, and 3.2%, respectively, based on the calcined weight of the catalyst. The zirconium oxide was introduced as a nitrate colloidal solution. The total loading of the middle layer was 1.55 g/in³. The OSC content in the layer was approximately 7.2%.

Palladium in the form of a palladium nitrate solution was impregnated by planetary mixer (P-mixer) onto the stabilized alumina to form a wet powder while achieving incipient wetness. An aqueous slurry was formed by combining all of the above components with water, and milling to a particle size of 90% less than 10 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The outer layer had the same composition, slurry preparation, and loading as the middle layer of this example.

### Example 6

### Comparative Example

A composite having a catalytic material was prepared using three layers: an inner layer, a middle layer, and an outer layer. In this example, the composition is generally referred to as UC/Pd/Rh (where UC refers to “undercoat”). The layered catalyst composite contained palladium and rhodium with a total precious metal loading of 80 g/ft³ and with a Pt/Pd/Rh ratio of 0/5/1. The substrate had a volume of 102.5 in³ (1.7 L) and a cell density of 600 cells per square inch and with wall thickness around 113 μm. The layers were prepared as follows:

### Inner Layer

The components present in the inner layer were high surface area gamma alumina, a ceria-zirconia oxide composite with 28% by weight ceria content, zirconium oxide, and a binder, at concentrations of approximately 22.7%, 68.2%, 4.5%, and 4.5%, respectively, based on the calcined weight of the catalyst. The total loading of the inner layer was 1.10 g/in³. The zirconium oxide was introduced as an acetate colloidal solution. The OSC content in the layer was approximately 19.1%.

An aqueous slurry was formed by combining all of the above components with water, and milling to a particle size of 90% less than 10 microns. The slurry was coated onto a cordierite carrier using deposition methods known in the art for depositing the catalyst on a cordierite substrate. After coating, the carrier plus the inner layer were dried and then calcined at a temperature of 500° C. for about 1 hour.

### Middle Layer

The components present in the middle layer were high surface area lanthana-stabilized gamma alumina, a ceria-zirconia oxide composite with 28% by weight ceria content, barium oxide, and palladium at concentrations of approximately 58.2%, 36.3%, 3.6%, and 1.9%, respectively, based on the calcined weight of the catalyst. The barium oxide was introduced as an acetate colloidal solution. The total loading of the middle layer was 2.1 g/in³. The OSC content in the layer was approximately 10.2%.

Palladium in the form of a palladium nitrate solution was impregnated by planetary mixer (P-mixer) onto the stabilized alumina to form a wet powder while achieving incipient wetness. An aqueous slurry was formed by combining all of the above components with water, and milling to a particle size of 90% less than 10 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The components present in the outer layer were high surface area stabilized gamma alumina, a ceria-zirconia oxide composite with 45% by weight ceria content, barium oxide, zirconium oxide, and rhodium, at concentrations of approximately 77.8%, 15.6%, 3.1%, 3.1%, and 0.5%, respectively, based on the calcined weight of the catalyst. The barium oxide and zirconium oxide were introduced as acetate colloidal solutions. The total loading of the outer layer was 0.88 g/in³. The OSC content in the layer was approximately 7.0%.

The rhodium in the form of a rhodium nitrate solution was impregnated by planetary mixer (P-mixer) onto the stabilized alumina to form a wet powder while achieving incipient wetness. An aqueous slurry was formed by combining all of the above components with water, and milling to a particle size of 90% less than 10 microns. The slurry was coated onto the cordierite carrier over the middle layer using deposition methods known in the art for depositing the catalyst on a cordierite substrate. After coating, the carrier plus the inner, middle, and outer layers were dried, and then calcined at a temperature of 500° C. for about 1 hour.

### Example 7

Testing

The catalyst composites prepared in Examples 5 and 6 were engine-aged for 50 hours at a maximum bed temperature of 950° C. After aging, the composites were evaluated using a simulated FTP-75 drive cycle.

TABLE 2

| | HC | CO/10 | NOₓ |
|---|---|---|---|
| | (modal mg/mi) | (modal mg/mi) | (modal mg/mi) |
| Example 5 | 18.2 | 33.4 | 10.8 |
| Example 6 | 20.6 | 37.2 | 13.3 |

Table 2 shows that the composite of Example 5 shows improved conversions of HC, CO, and NOₓ compared to composite of Example 6.

### Example 8

A composite having a catalytic material was prepared using three layers: an inner layer, a middle layer, and an outer layer. In this example, the composition is generally referred to as Rh/Pd/(Rh—Pt). The layered catalyst composite contained platinum, palladium, and rhodium with a total precious metal loading of 24 g/ft³ and with a Pt/Pd/Rh ratio of 3/14/6.7. The substrate had a volume of 37.9 in³ (0.6 L) and a cell density of 600 cells per square inch and with wall thickness around 113 μm. The layers were prepared as follows:

### Inner Layer

The components present in the inner layer were high surface area lanthana-stabilized gamma alumina, a ceria-zirconia oxide composite with 45% by weight ceria content, rhodium, a binder, and zirconium oxide, at concentrations of approximately 23.5%, 70.5%, 0.1%, 2.9%, and 2.9%, respectively, based on the calcined weight of the catalyst. The total loading of the inner layer was 0.85 g/in³. The zirconium oxide was introduced as an acetate colloidal solution. The OSC content in the layer was approximately 31.7%.

A portion of the rhodium in the form of a rhodium nitrate solution was impregnated by planetary mixer (P-mixer) onto the stabilized alumina to form a wet powder while achieving incipient wetness. The remainder of the rhodium in the form of a rhodium nitrate solution was impregnated by planetary mixer (P-mixer) onto ceria-zirconia composite having 45% ceria content to form a wet powder while achieving incipient wetness. An aqueous slurry was formed by combining all of the above components with water, and milling to a particle size of 90% less than 10 microns. The slurry was coated onto a cordierite carrier using deposition methods known in the art for depositing the catalyst on a cordierite substrate. After coating, the carrier plus the inner layer were dried and then calcined at a temperature of 500° C. for about 1 hour.

### Middle Layer

The components present in the middle layer were high surface area lanthana-stabilized gamma alumina, a ceria and zirconia oxide composite having 45% ceria, palladium, and barium oxide at concentrations of approximately 59.5%, 37.2%, 0.6%, and 2.8%, respectively, based on the calcined weight of the catalyst. The barium oxide was introduced as both a hydroxide and a nitrate colloidal solution. The total loading of the middle layer was 1.35 g/in³. The OSC content in the layer was approximately 16.7%.

Palladium in the form of a palladium nitrate solution was impregnated by planetary mixer (P-mixer) onto the stabilized alumina to form a wet powder while achieving incipient wetness. An aqueous slurry was formed by combining all of the above components with water, and milling to a particle size of 90% less than 10 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The components present in the outer layer were high surface area lanthana-zirconia-stabilized gamma alumina, a ceria-zirconia oxide composite with 45% by weight ceria content, zirconium oxide, a binder, platinum, and rhodium, at concentrations of approximately 40.1%, 53.5%, 3.3%, 2.7%, 0.1%, and 0.2%, respectively, based on the calcined weight of the catalyst. The zirconium oxide was introduced as an acetate colloidal solution. The total loading of the outer layer was 1.5 g/in³. The OSC content in the layer was approximately 24.1%.

The rhodium in the form of a rhodium nitrate solution and the platinum in the form of a platinum amine type solution was impregnated by planetary mixer (P-mixer) onto the stabilized alumina and OSC separately to form a wet powder while achieving incipient wetness. An aqueous slurry was formed by combining all of the above components with water, and milling to a particle size of 90% less than 10 microns. The slurry was coated onto the cordierite carrier over the middle layer using deposition methods known in the art for depositing the catalyst on a cordierite substrate. After coating, the carrier plus the inner, middle, and outer layers were dried, and then calcined at a temperature of 500° C. for about 1 hour.

### Example 9

### Comparative Example

A composite having a catalytic material was prepared using three layers: an inner layer, a middle layer, and an outer layer. In this example, the composition is generally referred to as UC/Pd/(Rh—Pt), where UC refers to undercoat. The layered catalyst composite contained platinum, palladium, and rhodium with a total precious metal loading of 25 g/ft³ and with a Pt/Pd/Rh ratio of 3/15/6. 37.9 in³ (0.6 L) and a cell density of 600 cells per square inch and with wall thickness around 113 μm. The layers were prepared as follows:

### Inner Layer

The components present in the inner layer were high surface area lanthana-stabilized gamma alumina, a ceria-zirconia oxide composite with 45% by weight ceria content, a binder, barium oxide, and zirconium oxide, at concentrations of approximately 29.2%, 58.5%, 2.9%, 3.5%, and 5.8%, respectively, based on the calcined weight of the catalyst. The total loading of the inner layer was 0.86 g/in³. The zirconium oxide was introduced as an acetate colloidal solution. The barium oxide was introduced as a nitrate colloidal solution. The OSC content in the layer was approximately 26.3%.

An aqueous slurry was formed by combining all of the above components with water, and milling to a particle size of 90% less than 10 microns. The slurry was coated onto a cordierite carrier using deposition methods known in the art for depositing the catalyst on a cordierite substrate. After coating, the carrier plus the inner layer were dried and then calcined at a temperature of 500° C. for about 1 hour.

### Middle Layer

The components present in the middle layer were high surface area lanthana-stabilized gamma alumina, a ceria-zirconia composite having 45% ceria content, palladium, and barium oxide at concentrations of approximately 76.7%, 18.4%, 0.6%, and 4.3%, respectively, based on the calcined weight of the catalyst. The barium oxide was introduced as both a hydroxide and a nitrate solution. The total loading of the middle layer was 1.63 g/in³. The OSC content in the layer was approximately 8.3%.

Palladium in the form of a palladium nitrate solution was impregnated by planetary mixer (P-mixer) onto the stabilized alumina to form a wet powder while achieving incipient wetness. An aqueous slurry was formed by combining all of the above components with water, and milling to a particle size of 90% less than 10 microns. The slurry was coated onto the cordierite carrier over the inner layer using deposition methods known in the art for depositing the catalyst on a cordierite substrate. After coating, the carrier plus the inner and middle layers were dried, and then calcined at a temperature of 550° C. for about 1 hour.

### Outer Layer

The components present in the outer layer were yttria-zirconia-stabilized alumina support, a ceria-zirconia oxide composite with 45% by weight ceria content, zirconium oxide, platinum, and rhodium, at concentrations of approximately 48.2%, 48.2%, 3.2%, 0.1%, and 0.2%, respectively, based on the calcined weight of the catalyst. The zirconium oxide was introduced as an acetate colloidal solution. The total loading of the outer layer was 1.56 g/in³. The OSC content in the layer was approximately 21.7%.

The rhodium in the form of a rhodium nitrate solution was impregnated by planetary mixer (P-mixer) onto the yttria-stabilized zirconia support to form a wet powder while achieving incipient wetness. The platinum in the form of an amine salt was impregnated by planetary mixer (P-mixer) onto the ceria-zirconia composite having 45% ceria content to form a wet powder while achieving incipient wetness. An aqueous slurry was formed by combining all of the above components with water, and milling to a particle size of 90% less than 10 microns. The slurry was coated onto the cordierite carrier over the middle layer using deposition methods known in the art for depositing the catalyst on a cordierite substrate. After coating, the carrier plus the inner, middle, and outer layers were dried, and then calcined at a temperature of 500° C. for about 1 hour.

### Example 10

Testing

The catalyst composites prepared in Examples 8 and 9 were lean-rich aged for 16 hours at a maximum bed temperature of 950° C. After aging, the composites were evaluated using a laboratory reactor system with various test protocols, including OBD delay time, model lambda transients, and simulated FTP drive cycles.

HC/CO/NOₓ conversions were measured while the temperature was rapidly raised to 500° C. Hydrocarbon, CO, and NOₓ concentrations were measured using a Fourier Transform Infrared (FTIR) analyzer.

TABLE 3

| | % NOₓ |
|---|---|
| | Residual |
| Example 8 | 0.9 |
| Example 9 | 2.9 |

Table 3 shows that the composite of Example 8 shows improved conversion of NOₓ compared to composite of Example 9. The design of Example 8 provided an outer layer having Rh on a thermally-stable support modified with a non-reactive layer and Pt on OSC composite to enhance ceria activation and water-gas shift reaction; a middle layer having Pd on stable alumina and OSC composite; and an inner layer having Rh on a thermally-stable highly porous alumina and Rh on an OSC composite to promote CO/NOx reaction during transients.

With respect to TPR performance, the catalyst according to Example 8 having Rh modified ceria provided a temperature of 161° C., whereas the catalyst of Example 9, without Rh, provided a temperature of 640° C.

### Example 11

A catalyst system was prepared having a front catalyst and a rear catalyst. The rear catalyst was prepared according to Example 8. The front catalyst was prepared using three layers: an inner layer, a middle layer, and an outer layer. In this example, the front catalyst composition is generally referred to as Pd/Rh/Pd. The layered catalyst composite contained platinum, palladium, and rhodium with a total precious metal loading of 87.8 g/ft³ and with a Pt/Pd/Rh ratio of 0/81/6.82. The substrate had a volume of 50.1 in³ (0.8 L) and a cell density of 600 cells per square inch and with wall thickness around 113 μm.

The system of Example 11 was aged. After 100 hours, the rear catalyst showed 0.027 g/mile weighted emissions for 3 bags during FTP testing. After 200 hours, the emissions for the rear catalyst was 0.029. This indicates good durability for the rear catalyst.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

The invention has been described with specific reference to the embodiments and modifications thereto described above. Further modifications and alterations may occur to others upon reading and understanding the specification. It is intended to include all such modifications and alterations insofar as they come within the scope of the invention.

What is claimed is:

1. A layered catalyst composite comprising: a catalytic material on a carrier, the catalytic material comprising first, second, and third layers, the first layer comprising a first precious metal selected from a first rhodium component on a first support, the second layer comprising a second precious metal selected from a second rhodium component on a second support, and the third layer comprising a third precious metal component on a third support; wherein the catalytic material is effective to substantially simultaneously oxidize carbon monoxide and hydrocarbons and reduce nitrogen oxides.

2. The composite of claim 1, wherein the catalytic material comprises the rhodium components in amounts to provide a rhodium loading in the catalytic material in the range of 1 to 14 g/ft³.

3. The composite of claim 1, wherein at least one of the supports is an oxygen storage component comprising a stabilized ceria-zirconia composite.

4. The composite of claim 1, wherein the first layer and the second layer are adjacent to each other.

5. The composite of claim 1, wherein the third layer is located between the first layer and the second layer, and the third precious metal component comprises a palladium component.

6. The composite of claim 1, wherein the first, second, and third supports each independently comprise compound that is activated, stabilized, or both selected from the group consisting of alumina, silica, silica-alumina, alumino-silicates, alumina-zirconia, lanthana-alumina, lanthana-zirconia-alumina, baria-alumina, baria-lanthana-alumina, baria-lanthana-neodymia-alumina, alumina-chromia, and alumina-ceria.

7. The composite of claim 1, wherein the first layer, the second layer, or both further comprise a platinum component.

8. The composite of claim 1, wherein the third layer is deposited on the carrier as an inner layer, the third precious metal component comprises a palladium component; and the third support comprising a high surface area refractory metal oxide; the first layer is deposited on the third layer as a middle layer; and the second layer is deposited on the first layer as an outer layer, and the second support comprises a high surface area refractory metal oxide, and the second layer further comprises an oxygen storage component.

9. The composite of claim 8, wherein
the inner layer comprises a stabilized alumina and palladium, and is substantially free of an oxygen storage component;
the middle layer comprises a stabilized alumina and is substantially free of an oxygen storage component; and
the outer layer comprises a stabilized alumina, one or more ceria-zirconia oxide composites to provide ceria in an amount in the range of 15 to 30% by weight of the layer, and rhodium.

10. The composite of claim 8, wherein
the inner layer comprises a stabilized alumina and palladium, and is substantially free of an oxygen storage component;
the middle layer comprises one or more ceria-zirconia oxide composites to provide ceria in an amount in the range of 15 to 30% by weight of the layer and rhodium, and is substantially free of an alumina component; and
the outer layer comprises a stabilized alumina; one or more ceria-zirconia oxide composites to provide ceria in an amount in the range of 15 to 30% by weight of the layer, and rhodium.

11. The composite of claim 8, wherein
the inner layer comprises a stabilized alumina, palladium, and one or more ceria-zirconia oxide composites to provide ceria in an amount in the range of 15 to 30% by weight of the layer; and
the middle layer and the outer layer have substantially the same composition, each comprising one or more ceria-zirconia oxide composites to provide ceria in an amount in the range of 5 to 15% by weight of the layer, rhodium, and a stabilized alumina.

12. The composite of claim 1, wherein the first layer is deposited on the carrier as an inner layer, the first support comprises a high surface area refractory metal oxide; the third layer is deposited on the first layer as a middle layer, the third precious metal component comprises a palladium component; and the second layer is deposited on the middle layer as an outer layer, the second support comprises a high surface area refractory metal oxide support, and the second layer further comprises an oxygen storage component.

13. The composite of claim 12, wherein
the inner layer comprises a stabilized alumina, rhodium, and one or more ceria-zirconia oxide composites to provide ceria in an amount in the range of 20 to 40% by weight of the layer;
the middle layer comprises a stabilized alumina, palladium, and one or more ceria-zirconia oxide composites to provide ceria in an amount in the range of 5 to 20% by weight of the layer; and
the outer layer comprises a stabilized alumina, rhodium, platinum, and one or more ceria-zirconia oxide composites to provide ceria in an amount in the range of 15 to 40% by weight of the layer.

14. The composite of claim 13, wherein at least one layer comprises a lanthana-stabilized alumina.

15. An exhaust gas treatment system comprising a combination of a first composite and a second composite, wherein the first composite comprises a first inner layer deposited on a first carrier comprising a palladium component and a support, a first middle layer deposited on the first inner layer, the first middle layer comprising a rhodium component and a support, and a first outer layer deposited on the first middle layer, the first outer layer comprising a palladium and a support; and wherein the second composite comprises a second inner layer deposited on the first carrier or on a second carrier, the second inner layer comprising a rhodium component and a support, a second middle layer deposited on the second inner layer, the second middle layer comprising a palladium component and a support, and a second outer layer deposited on the second middle layer, the second outer layer comprising a rhodium component and a support.

16. The system of claim 15, wherein the first composite is located upstream of the second composite.

17. The system of claim 15, wherein the second composite is located upstream of the first composite.

18. A method for treating a gas comprising hydrocarbons, carbon monoxide, and nitrogen oxides comprising: contacting the gas with a catalytic material on a carrier, the catalytic material comprising three layers, wherein at least two layers each comprise a rhodium component and a support, the support of one of the at least two layers comprises an oxygen storage component, and a third layer comprises a precious metal component and a support; wherein the catalytic material is effective to substantially simultaneously oxidize the carbon monoxide and the hydrocarbons and reduce the nitrogen oxides.

19. The method of claim 18, further comprising locating the catalytic material in a close-coupled position of an exhaust gas treatment system wherein the catalytic material comprises an inner layer, a middle layer, and an outer layer, the inner layer being deposited on the carrier and comprising a first rhodium component on a first support, the middle layer being deposited on the inner layer and comprising a palladium component on a second support, and the outer layer being deposited on the middle layer and comprising a second rhodium component on a third support; wherein the catalytic material comprises the rhodium components in amounts to provide a rhodium loading in the catalytic material in the range of 1 to 14 g/ft³, and the catalytic material comprises the palladium component in an amount to provide a palladium loading in the catalytic material in the range of 20 to 200 g/ft³.

20. The method of claim 18, further comprising locating the catalytic material in an underfloor position of an exhaust gas treatment system wherein the catalytic material comprises an inner layer, a middle layer, and an outer layer, the inner layer being deposited on the carrier and comprising a first rhodium component on a first support, the middle layer being deposited on the inner layer and comprising a palladium component on a second support, and the outer layer being deposited on the middle layer and comprising a second rhodium component on a third support; wherein the catalytic material comprises the rhodium components in amounts to provide a rhodium loading in the catalytic material in the range of 1 to 14 g/ft³, and the catalytic material comprises the palladium component in an amount to provide a palladium loading in the catalytic material in the range of 5 to 30 g/ft³.

21. A method of making a layered catalyst composite, the method comprising providing a carrier and coating the carrier with first, second, and third layers of catalytic material; wherein at least two layers each comprise a rhodium component, one of the at least two layers comprising the rhodium component comprises an oxygen storage component, and a third layer comprises a precious metal component and a support.

22. The method of claim 21, comprising depositing the at least two layers comprising the rhodium component adjacent to each other.

23. The method of claim 21, comprising depositing one of the at least two layers comprising the rhodium component on the carrier, depositing the third layer on the first layer, and depositing the other of the at least two layers comprising the rhodium component on the third layer.

24. A layered catalyst composite comprising: a catalytic material on a carrier, the catalytic material comprising an inner layer, a middle layer, and an outer layer, the inner layer deposited on the carrier comprising a first rhodium component on a first support, the middle layer deposited on the inner layer comprising a palladium component on a second support, and the outer layer deposited on the middle layer comprising a second rhodium component on a third support; wherein the catalytic material is effective to substantially simultaneously oxidize carbon monoxide and hydrocarbons and reduce nitrogen oxides; wherein the catalytic material comprises the rhodium components in amounts to provide a rhodium loading in the catalytic material in the range of 1 to 14 g/ft³, and the catalytic material comprises the palladium component in an amount to provide a palladium loading in the catalytic material in the range of 5 to 200 g/ft³.

25. The composite of claim 24, wherein the palladium component is present in an amount to provide a palladium loading in the catalytic material in the range of 5 to 30 g/ft³.

26. The composite of claim 24, wherein the inner layer, the outer layer, or both further comprise a platinum component in an amount in the range of 1 to 6 g/ft³.
